(19) United States
(12) Patent Application Publication
(10) Pub. No.: US 2017/0127378 A1
(43) Pub. Date: May 4, 2017

(54) INTERACTIVE COHORT PROXIMITY NOTIFICATION SYSTEM

(71) Applicant: Qwyker, Inc., LOS GATOS, CA (US)

(72) Inventors: Vishney Rene, Pleasant Hill, CA (US); Sundar Mudupalli, San Jose, CA (US); Prokopis M. Musuris, San Jose, CA (US); Donald Rector, Pleasant Hill, CA (US)

(21) Appl. No.: 15/337,290

(22) Filed: Oct. 28, 2016

Related U.S. Application Data
(60) Provisional application No. 62/248,901, filed on Oct. 30, 2015.

(51) Int. Cl. H04W 64/00; H04W 4/02; G06F 3/14; H04L 12/58; H04W 4/08; G01S 19/13; H04W 8/00

(52) U.S. Cl. CPC H04W 64/006; G01S 19/13; H04W 4/023; H04W 4/022; H04W 8/005; H04L 51/04; H04W 4/08; G06F 3/14; G06F 3/04842

(57) ABSTRACT

An electronic cohort location method that enables subscribers to interactively communicate data and positional status, such as instantaneous geographical coordinates obtained from a GPS (global positioning satellite) system or GPS-enabled device, and share their relative positions between a select group of identified cohorts seeking electronic notification of the identity, location and other shareable descriptive parameters associated with other selected cohorts when they become physically proximate to within a predetermined distance of one another.

### FIELD OF THE INVENTION

The present invention relates in general to an electronic cohort location method that enables subscribers to interactively communicate data and positional status within a select group of identified cohorts seeking electronic notification of the identity, location and other shareable descriptive parameters associated with other selected cohorts when they become physically proximate to within a predetermined distance of one another.

### BACKGROUND

Current methods of connecting people who are on the move are limited to approaches that can accurately obtain and then share one's physical location data, such as a GPS (global positioning satellite) map location as expressed in global longitudinal and latitudinal coordinates with another. Owing to privacy concerns and tracking of an individual's location via monitoring of their portable electronic devices and communications means (cell phones and the like), many people elect to disable their tracking or location services.

What would be more desirable however, is a method of enabling only those selected entities, such as friends, family members and the like, the means to monitor one's location. Even more desirable would be a method of alerting a user when a selected entity comes within a preselected distance or perimeter of that user, but which does not enable tracking or reporting of the user's location to non-selected entities.

### SUMMARY OF THE INVENTION

The present disclosure relates generally to an electronic cohort location method that operates to track the geophysical location of a user and other subscribers by means of monitoring the location of one or more electronic devices associated with the user and subscribers.

The present disclosure further relates to an electronic cohort location method that operates to enable the calculation of the physical and/or temporal distances between selected cohorts by means of obtaining the geophysical locations of a first user and selected cohorts and then calculating the relative physical distance between the pairs of the user and each selected cohort.

The present disclosure further relates to an electronic cohort location method that operates to enable the calculation of the physical and/or temporal distances between selected cohorts by means of obtaining the geophysical locations of a first user and selected cohorts and then calculating the relative physical distance between the pairs of the user and each selected cohort in order to determine if any one of the pairs of user and cohorts are physically located proximate to each other within a preselected perimeter distance.

The present disclosure further relates to an electronic cohort location method that operates to enable the calculation of the physical and/or temporal distances between selected cohorts by means of obtaining the geophysical locations of a first user and selected cohorts, calculating the relative physical distance between the pairs of the user and each selected cohort in order to determine if any one of the pairs of user and cohorts are physically located proximate to each other within a preselected perimeter distance, and then identifying or displaying one or more sets of cohort's or their associated data to the user by means of the user's electronic device's display screen or output means.

The present invention further relates to an electronic cohort location method that enables subscribers to interactively communicate data and positional status within a select group of identified cohorts seeking electronic notification of the identity, location and other shareable descriptive parameters associated with other selected cohorts when they become physically proximate to within a predetermined distance of one another.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a schematic diagram of one embodiment of a user network interface hosting the disclosed electronic cohort location method software, analysis modules and storage databases including interface devices used by subscribers and customer users.

FIG. 2 is a schematic block diagram of one embodiment of a electronic cohort location method showing the steps involved in locating the physical position of a user from a list of subscribers, identifying a set of cohorts who are physically close and reporting that set of cohort(s) to that user.

### LEXICOGRAPHY

Unless otherwise defined in the attached specifications, the following words should be construed accordingly.

The terms “user”, “subscriber” and “cohort” all collectively refer to a collective set of people subscribing to or using the presently disclosed electronic cohort location method.

The term “cohort database” refers to a computer database or other such electronically based storage medium that operates to receive and store data (information) corresponding one or more subscribers or users of the presently disclosed electronic cohort location method.

The term “cohort interface website” generally refers to a real or virtual webpage or world wide web access point that operates to provides an access point to operate the electronic cohort location method, access points including, but not limited to direct line, internet, wi-fi and wireless access point connectivity, in order to facilitate communications (the uploading, exchange, downloading, storage and manipulation of data) between multiple cohorts and the computer system employed to host and execute the electronic cohort location method as disclosed herein.

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The word “middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “Internet Protocol Security” (IPsec) generally means a protocol suite for securing Internet Protocol (IP) communications by authenticating and encrypting each IP packet of a communication session.

The term “Kernel” generally means the core of the operating system. It normally has full access to all memory and machine hardware and is conventionally a restricted operating area.

The term “service level agreement” (SLA) generally means an agreement between providers for Internet based computing resources such as servers, databases, and data storage systems and clients. SLAs generally contain details about what services are available, pricing for those services and availability for those resources. SLAs may also include workload, queue size, disk space availability, CPU load, network latency, or business metrics such as cost or location.

The term “User Space” generally refers to a software architecture that restricts user programs so they can't alter memory (and other resources) owned by other programs or by the OS kernel.

The term “virtual machine” or “VM” generally refers to a self-contained operating environment that behaves as if it is a separate computer even though is part of a separate computer or may be virtualized using resources from multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

One general embodiment of the present disclosure is an electronic cohort location method that operates to track the geophysical location of a user and other subscribers by means of monitoring the location of one or more electronic devices associated with the user and subscribers.

A second general embodiment of the present disclosure is an electronic cohort location method that operates to enable the calculation of the physical and/or temporal distances between selected cohorts by means of obtaining the geophysical locations of a first user and selected cohorts and then calculating the relative physical distance between the pairs of the user and each selected cohort.

A third general embodiment of the present disclosure is an electronic cohort location method that operates to enable the calculation of the physical and/or temporal distances between selected cohorts by means of obtaining the geophysical locations of a first user and selected cohorts and then calculating the relative physical distance between the pairs of the user and each selected cohort in order to determine if any one of the pairs of user and cohorts are physically located proximate to each other within a preselected perimeter distance.

A fourth general embodiment of the present disclosure is an electronic cohort location method that operates to enable the calculation of the physical and/or temporal distances between selected cohorts by means of obtaining the geophysical locations of a first user and selected cohorts, calculating the relative physical distance between the pairs of the user and each selected cohort in order to determine if any one of the pairs of user and cohorts are physically located proximate to each other within a preselected perimeter distance, and then identifying or displaying one or more sets of cohort's or their associated data to the user by means of the user's electronic device's display screen or output means.

A fifth general embodiment of the present disclosure is an electronic cohort location method that enables subscribers to interactively communicate data and positional status within a select group of identified cohorts seeking electronic notification of the identity, location and other shareable descriptive parameters associated with other selected cohorts when they become physically proximate to within a predetermined distance of one another.

### Specific Embodiments

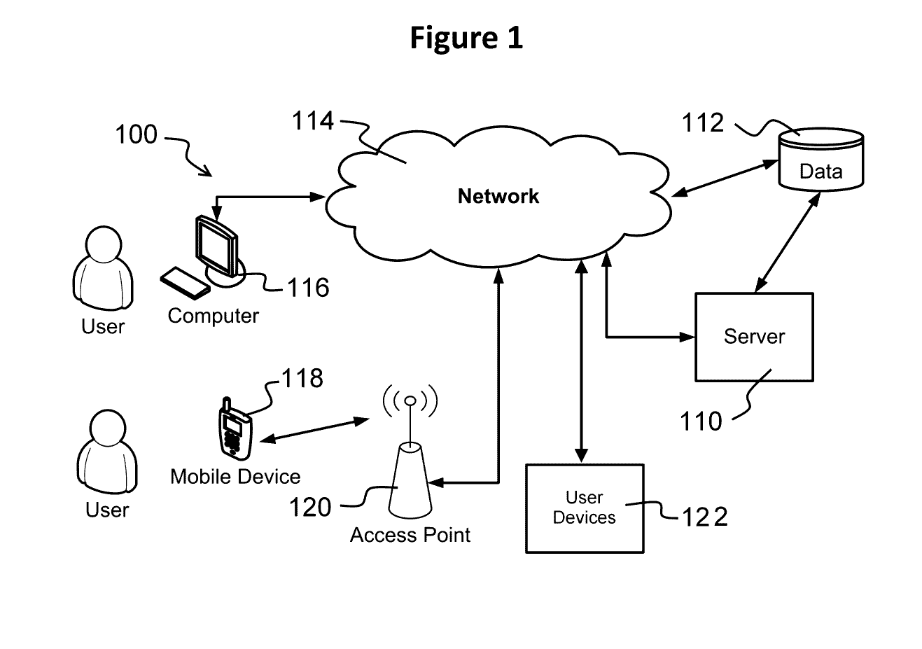

FIG. 1 shows a functional block diagram of an electronic cohort location method 100 that may be employed for some embodiments of the current disclosure. The embodiment of the present disclosure shown in FIG. 1 details system components of an electronic cohort location method 100, showing various interface devices, such as a computer 116 and mobile device 118, both devices 116 and 118 being employed by users to communicate data and resulting calculations of the electronic cohort location method by means of a network 114 that provides a means for communication with users through an access point 120 (optionally via cable, wire, wireless transmission, wi-fi, ethernet, phone line or other similar electronic communications system) in addition to a means for data storage 112. In further embodiments, the electronic cohort location method also features a server 110 hosting the algorithms and programs employed by one or more devices used to collect, store and analyze data, and other user devices 122 as required. In one embodiment, the server 110 hosts a data storage device 112 and operates via the network 114 for either direct access (shown by the connected arrows between computer 116 and network 114) or remote access by users for the purpose of communicating using a remote device such as access point 120. In other embodiments, the user devices 122 include a means for inputting and exporting data, storing and accessing said data, performing calculations and analysis on said data, storing and accessing results of said calculations and analysis, and reporting said results of said calculations and analysis to a user, optionally, but not limited to means including a computer 116 or smart phone or mobile device 118, or the like. In other embodiments of the disclosure, the electronic cohort location method 100 employs a computer or other similar calculating device capable of executing coded instructions derived from algorithms and computer programs, and communicates via said computer with the data 112, server 110 and network 114 devices by means of user interfaces 116 and 118, as well as via other user devices 122 described herein. With respect to the operative modules that can be employed by the disclosed electronic cohort location method, FIG. 1 shows a server 110 coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

In further embodiments of the present disclosure, the computer 116, mobile device 118 and other user devices 122, are preferentially selected to include a means to determine or report their physical locations by means of location coordinates, such as but not limited to a GPS (global positioning satellite) signal or GPS coordinate, or latitudinal and longitudinal global coordinates. In a related embodiment of the present disclosure, the computer 116, mobile device 118 and other user devices 122, are preferentially selected to include a means to determine or report their physical altitude above normal sea level or with respect to local geographical altitudes (i.e. ground level) by means of an altimeter, air pressure detection means, and the like.

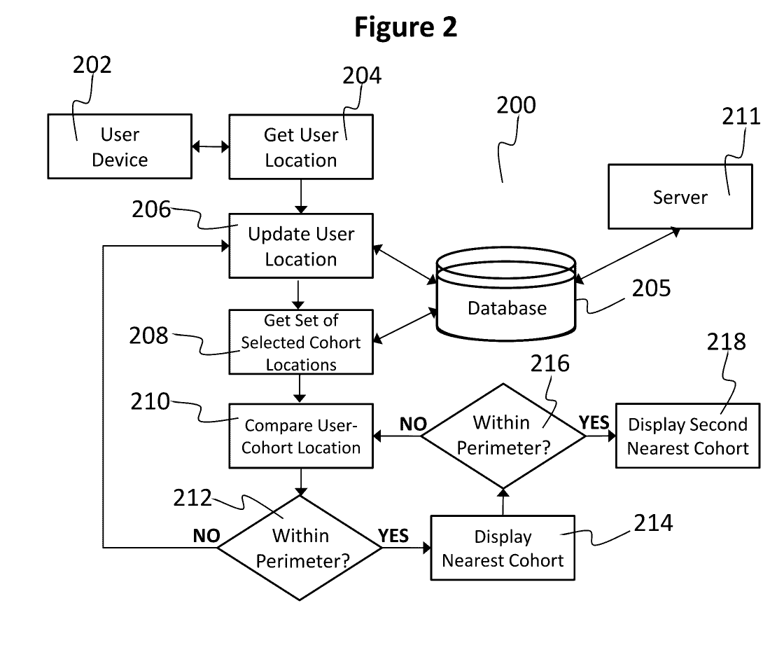

Another embodiment of the present disclosure related to a cohort location business method 200 is shown schematically in FIG. 2. In this embodiment of a cohort location business method 200, a user device 202, which may be selected from, but is not limited to, a automobile, cell-phone, wrist phone, personal electronic device, pager, tablet, computer, smart pad, and the like, hosts an application (computer code) that operates to continuously get the user's location in step 204 and then updates that user's location in step 206 by sending the user's updated location information to a database 205. In one embodiment, step 204 is completed by using a communications chip or GPS-enabled chip located on the user device 202 to determine the geophysical coordinates of the user device 202 and translate these to a suitable form of coordinates to identify the user's current location. In an alternative embodiment, step 204 is completed by other means, such as but not limited to, obtaining triangulation data from at least three separate locational beacons or wireless access points having known, fixed, geophysical locations, and then calculating the relative position of the user device 202 with respect to the three fixed reference points corresponding to the geophysical location of the locational beacons or wireless access points. In another related embodiment, step 204 is completed by means of receiving and identify a locational beacon or signal originating from a known physical location, such as but not limited to, locational beacons from an airplane, buoy, car, airport tower, business location, antenna, home, satellite, communications tower, cell tower, radio transmission tower, utility, mobile vehicle, train, transportation facility (e.g. subway, train, bus station), state or governmental facility, and the like. In this embodiment, the locational beacon or signal optionally includes the name or identification or description of the physical site from which the locational beacon originates for the purpose of more readily identifying the location indicated by the positional data encoded within the locational beacon or signal, for example, the coordinates of a train station and the accompanying descriptive textual string “Central Station” to identify the source of the beacon. In a related embodiment, the database 205 associated with the disclosed cohort location business method stores the descriptive textual string corresponding to known locational beacons and signals, so that the user's relative geophysical distance from the source of the locational beacon can be determined, but the name or textual description of the known locational beacon can be associated with, and displayed along with the calculated distance values. For example, in one embodiment of the cohort location business method, a Starbucks store transmitting a wi-fi signal received by the user device 202 can be identified to the user by name, enabling the cohort location business method to display a message such as “You are 250 feet from Starbucks.” In a further embodiment, the database 205 stores the name and optionally a nick-name or “handle” of a selected cohort, so that the cohort's identity can be associated with the calculated distance values, enabling the cohort location business method to display a message such as “You are 100 feet from Crazy Larry,” “Crazy Larry” being the optional nick-name associated with a particular selected cohort, Larry, stored within that particular cohort's data record 203.

In one embodiment of the cohort location business method, a database 205 is used to store the user and subscriber information (see Table 1) in a plurality of data records 203 (not shown) that each include the name, and optionally nick-name, and present or last-known location of the list of subscribers or selected cohorts who are to be included in a particular user's list of cohorts enabled for reporting by the cohort location business method. In one embodiment, the data record 203 of a selected user contains only the current selected list or records of those individuals and locations specifically selected by the user to be included in the locational search. In a related embodiment, the data base 205 contains a plurality of data records 203 that comprises the records of all subscribers to the cohort location business method as disclosed herein, including name, optionally a nick-name, the last-known location of that cohort, and a list of selected cohorts with which the particular user desires to be associated with, so that only the selected cohorts of a particular user are being tracked with regards to their current position with respect to the user.

TABLE 1
List of Cohort Data and Factors

| Factor # | Tenant Factors |
|---|---|
| 1 | Name |
| 2 | Nickname |
| 3 | Non specific (default) perimeter notification distance |
| 4 | Current physical location |
| 5 | Cohort 1 |
| 6 | Cohort 1 perimeter notification distance |
| 7 | Cohort 2 |
| 8 | Cohort 2 perimeter notification distance |

In one embodiment, the cohort location business method updates the user location 206 by sending the updated user coordinates or locational data to a database 205, where a data record 203 (not shown) is then updated to reflect any changes to the data entry and also updated to reflect the current position of that user. Next, the cohort location business method operates to query the database 205 to identify the list of one or more previously user-selected cohorts whose geophysical locations are to be collected and used to calculate their respective individual distances from that of the user, or in other words, to calculate how far apart at that particular time the user's device is from a device being used by the selected cohort.

In another embodiment, cohort location business method operates to compare the locations of the user and selected cohort(s) in step 210 in order to determine their relative separation or distance from each other. In one embodiment of the present disclosure, the calculations may be performed using any suitable coordinate system, and results of the calculations relating to distance can be completed and reported in any desired notational form, including but not limited to inches, feet, miles, centimeter, decimeters, meters, kilometers, and light years. In an alternative embodiment of the present disclosure, the calculations may be performed using any suitable coordinate system, and results of the calculations relating to distance can be completed and transformed into an equivalent time measurement indicative of how far apart the user and selected cohort(s) are with respect to a means of transport that would bring the two entities together, such as for example, by walking, by automobile or motor vehicle, by taxi, by Uber vehicle, by bus, by train, by subway, by airplane, by hypertube, rocket ship, by shuttle or other public transportation means.

In a further embodiment, the cohort location business method employs a server 211 that is communication with the database 205, the latter serving the purpose of storing, updating and sharing user and cohort data present in one or a plurality of data records 203. In a related embodiment, the cohort location business method employs a server 211 to remain in communication with a database 205 that holds one or a plurality of cohort data records 203 (not shown) that are created, updated, or optionally deleted by one or more users and cohorts. In related embodiment, the one or more users and cohorts employ an electronic user device 202, such as for example, but not limited to a cell phone, to join the subscription service associated with the cohort location business method, create a subscriber or cohort data record, update that record, and/or delete that record. In a further embodiment, the one or more users and cohorts employ an electronic user device 202, which runs software associated with the disclosed method that operates to get the user's current location in a first step 204, communicate that user's updated location in a following step 206 to said database 205, either automatically at a preselected time interval or manually when this option is selected by the user.

In step 212 of the disclosed cohort location business method, the calculated distance between the user and a first selected cohort is compared to a predetermined perimeter value to determine if the distance between the entities is less than, the same, or greater in value than that predetermined perimeter value. If step 212 determines that the user-cohort distance exceeds the perimeter value, than the logic module associated with step 212 reports a NO or FALSE value, and directs the cohort location business method to continue monitoring user's location and comparing the user's present location to the present location(s) of the selected cohort(s) located within the database 205.

Alternatively, if step 212 determines that the user-cohort distance is less than or equal to the perimeter value, than the logic module associated with step 212 reports a “YES” or TRUE value, indicative of the finding of a cohort (i.e. a cohort's device) that is proximate to the user's location, and directs the user's device 202 to display the name, and optionally the name and optionally the calculated distance or time equivalent between the user and that particular cohort on the user device 202's display screen or output means.

In yet another embodiment of the disclosure, once one proximate cohort is found and identified, the cohort location business method utilizes an additional step 216 to determine whether a second (or alternatively a third, or yet alternatively a fourth, and so forth) cohort is also within the predetermined perimeter distance of the first user. In one embodiment, the logic module associated with step 216 may report a NO or FALSE value, and would then direct the cohort location business method to continue monitoring or updating the user's location at either step 204 or step 206, respectively, and then continuing with steps 208 through steps 216 in comparing the user's present location to the present location(s) of the selected cohort(s) located within the database 205.

In a related embodiment to that disclosed immediately above, the logic module associated with step 216 may report a “YES” or TRUE value, indicative of the finding of a second (or third, etc.) cohort (i.e. a cohort's device) that is also proximate to the user's location, and directs the user's device 202 to display the name, and optionally the name and optionally the calculated distance or time equivalent between the user and that particular cohort on the user device 202's display screen or output means.

In a further embodiment of the disclosure, cohort location business method also includes a step 220 (not shown) that operates to alternatively display the identity of a first cohort in step 214 and that of a second cohort in step 218 either simultaneously, or alternatively by first displaying the identity of the first cohort and then displaying the identify of a second cohort (and optionally a third, a fourth, and so on) after a preselected time period, such as for example, after a brief time period of 100 milliseconds to a couple of seconds in duration, the preselected time period being sufficient for the user to observe the displayed information in order to identify the cohort's identity being displayed, and optionally other information associated with that cohort that is stored within the reportable cohort's data records 203 that are stored within the database 205.

In another embodiment of the present disclosure, the database 205 may optionally be associated with a network 114 and a cloud network 115, or combination of the two, for the purpose of storing, updating and sharing user and cohort data present in one or a plurality of data records 203.

### System Elements

### Processing System

The methods and techniques described herein may be performed on a processor based device. The processor based device will generally comprise a processor attached to one or more memory devices or other tools for the input, storage and output of data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

The mass storage device may host a subscriber database that operates to store a set of subscriber data and personal information relating to each subscriber, including a list of selected cohorts that each particular subscriber has selected to be actively included, by means of enabling the use of their respective personal information stored within the database, combined with information relating to that particular subscriber's physical location, in order to enable tracking and calculation of the location and relative proximity of each selected cohort with respect to another.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” or “module” which include processor-readable instructions (or “executable” code) to effectuate different elements of a design. Each engine may be responsible for differing operations and may reside in whole or in part on a client, server or other device. As disclosed herein a display engine for user interoperability, a data engine for data storage and processing, an execution engine for method processing, and a user interface (UI) engine and the like may be employed. These engines may seek and gather information about events from remote data sources and provide information to, and collect information from users.

### Operation

In operation the following steps may be effectuated. First, identify cohorts in an identified group. Then define the perimeter distance for pairing cohorts. Once cohorts and distances are known, monitor the distance apart of cohorts until any two are within the defined perimeter distance. When two members of the cohort are within the defined perimeter distance, turn on the first indicia for a remote device. Displaying an indicia may be effectuated using the screen of a cell-phone, tablet or other wireless device, or in other embodiments sending a text message or email. The text or email may provide a link or processor instructions to display an indicia. Moreover, after a predetermined time or when the cohorts get within a predetermined distance, the indicia may change thus indicating closeness.

If the cohort has more than two members, the operation may continue to turn on alternating indicia as the new members are within the perimeter or other predetermined distance.

Monitoring may be effectuated by periodic polling of the cohort's location information or providing the remote device with processor instructions wherein the remote device is instructed to track it's own position and report to a centralized server location information at predetermined times or locations or in response to request for information.

1. A method including the steps of:
receiving a cohort member information;
receiving a cohort location information;
receiving a perimeter information;
monitoring said location information of cohorts, and
displaying an indicia when the cohorts are within a predetermined distance.

2. The method of claim 1 wherein the step of receiving cohort member information includes receiving, over a wireless network, at least an identification of a member of a group.

3. The method of claim 1 wherein receiving cohort location information includes receiving, over a wireless network, at least one of a global positioning information or a latitude and longitude information.

4. The method of claim 1 wherein the cohort perimeter information includes either a predetermined distance or a user-selectable perimeter information.

5. The method of claim 1 wherein said displaying an indicia includes displaying, on an electronic device, at least one of a cohort information, a positional status, or a relative distance position.

6. The method of claim 1 wherein said indicia includes a time calculation of distance between cohorts or a text message displayed on a wireless electronic device.

7. The method of claim 1 wherein said displaying an indicia includes sending a text message or email.

8. The method of claim 1 wherein said displaying an indicia includes displaying differing indicia in response to said monitoring, wherein a different indicia is display for different distances between cohort members.

9. The method of claim 1 wherein said monitoring includes polling a plurality of cohort location information and calculating the distance between them and comparing the distance to the perimeter information.

10. The method of claim wherein said monitoring includes polling a plurality of cohort location information and calculating the travel time between them and comparing that travel time to the perimeter information.

11. One or more processor-readable storage devices having non-transitory, processor-readable instructions encode thereon, said instructions directing a processor to perform a method comprising:
receiving a plurality of cohort member information;
receiving a plurality of cohort location information;
receiving a perimeter distance information;
monitoring the cohort location information, and
transmitting an indication when at least two or more of said plurality of cohorts location information are within the perimeter distance.

12. The device of claim 11 wherein said monitoring includes periodically receiving the cohort location indication and calculating a distance between two or more cohorts.

13. The device of claim 11 wherein said indication includes either a time indication or a distance indication.

14. The device of claim 11 wherein said processor-readable storage device is coupled to a server.

15. The device of claim 14 wherein said transmitting includes transmission over a network to a network coupled wireless device.

16. The device of claim 11 wherein said indicia includes a time calculation of distance between cohorts displayed on a wireless electronic device.

17. The device of claim 11 wherein said displaying an indicia includes sending a text message or email.

18. The device of claim 11 wherein said displaying an indicia includes displaying differing indicia in response to said monitoring, wherein a different indicia is display for different distances between cohort members.

19. A method comprising:
receiving, over a network, a set of cohort membership information, said membership information including at least one descriptive parameter for each cohort member;
receiving perimeter information;
receiving, periodically, location information from one or more members of the cohort;
comparing that location information to calculate when any member of the cohort is within the perimeter of another member of the cohort, and
transmitting to at least one of the cohort members, an indication representing the results of said comparing.

20. The method of claim 19 wherein said indication includes a display on a mobile device.
